(19) United States
(12) Patent Application Publication
(10) Pub. No.: US 2005/0013593 A1
(43) Pub. Date: Jan. 20, 2005

(54) Method and apparatus for guaranteeing seamless reproduction of a plurality of data streams

(75) Inventors: Kil-soo Jung, Hwaseong-gun (KR); Seong-jin Moon, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/809,817

(22) Filed: Mar. 26, 2004

Related U.S. Application Data
(60) Provisional application No. 60/458,412, filed on Mar. 31, 2003.

(30) Foreign Application Priority Data
Mar. 28, 2003 (KR) 2003-19682
Mar. 10, 2004 (KR) 2004-16101

(51) Int. Cl. H04N 5/76

(52) U.S. Cl. 386/98; 386/124

(57) ABSTRACT

A method of and an apparatus for guaranteeing seamless reproduction of data streams. The method relates to seamlessly reproducing of a plurality of data streams that include packet data with arrival time stamps determined to be unrelated to each other, the method including generating control information for controlling output times of the plurality of data streams for seamless reproduction, and continuously reproducing the plurality of data streams based on the generated control information. In particular, the control information may specify a reference time value and one of reproduction a gap length value and an offset value. Accordingly, a plurality of SOBs, ATSs of packet data of which are determined to be unrelated to each another may be seamlessly reproduced by adjusting the ATSs of packet data of subsequent SOBs using a reference time value.

### CROSS-REFERENCE TO RELATED APPLICATIONS

This application claims the benefit of Korean Patent Application Nos. 2003-19682, filed on Mar. 28, 2003, and 2004-16101, filed on Mar. 10, 2004, in the Korean Intellectual Property Office, and U.S. Provisional Application No. 60/458,412, filed on Mar. 31, 2003 in the U.S. patent and Trademark Office, the disclosures of which are incorporated herein by reference.

### BACKGROUND OF THE INVENTION

1. Field of the Invention

The present invention relates to reproduction of multimedia data, and more particularly, to a method and apparatus for guaranteeing seamless reproduction of a plurality of data streams.

2. Description of the Related Art

In general, multimedia data is compressed and encoded according to a moving picture experts group (MPEG) standard and then recorded on a storage medium. The compressed and encoded data is divided into predetermined-sized packets and recorded on the storage medium. Multimedia data, such as video and/or audio (AV) data, which is compressed, encoded, and divided into predetermined-sized packets, will be referred to herein as ‘packet data’. Packet data may be recorded on a storage medium or transmitted via a satellite, a cable, or a local area network (LAN). A size of packet data is determined according to the moving picture experts group standard used. For instance, a size of packet data is determined to be 188 bytes long when using MPEG-2 transport streams according to an ISO/IEC 13818-1 standard, and determined to be 53 bytes long when using the asynchronous transfer mode (ATM) standard.

FIG. 1 illustrates a basic format of packet data recorded to include arrival time stamps (ATSs), and a relationship between the ATSs and output time when the packet data is reproduced.

A recording apparatus adds ATSs (e.g., 100, 110, 130 and 150) to input packet data and records the packet data including the ATSs on a storage medium. The ATSs indicate when packet data is input to the recording apparatus. A reproducing apparatus reads the packet data including the ATSs from the storage medium and controls output time of the packet data based on the ATSs.

In digital broadcasting, multimedia data is transmitted in a packet format at irregular intervals of time. The transmitted packet data is sent to a decoder via a buffer at a receiving side and decoded by the decoder so that a user can view a result of the digital broadcasting.

Meanwhile, when recording packet data on a storage medium and reproducing the packet data from the storage medium at a desired point of time, the reproducing apparatus reads the packet data from the storage medium and outputs the packet data to the decoder. When outputting the packet data to the decoder, irregular intervals of time at which the original packet data was transmitted to the recording apparatus are significant. The irregular intervals of time were determined by a transmitting side so that intervals between packet data that are to be decoded are appropriate and do not cause overflow or underflow of the buffer at a receiving side. If the receiving side does not decode the packet data based on the irregular intervals of time, seamless reproduction of multiple data is not ensured due to overflow or underflow of the buffer at the receiving side. That is, seamless reproduction of multimedia stream data is not guaranteed. Therefore, a recording apparatus records input packet data together with respective ATSs and a reproducing apparatus controls reproduction of the packet data based on the recorded ATSs.

FIG. 2 is a block diagram of a conventional recording/reproducing apparatus that records and/or reproduces the packet data of FIG. 1. Referring to FIG. 2, the recording apparatus includes a counter, an ATS generator, and a recording controller, and the reproducing apparatus includes a reproduction controller, a counter, and an ATS processor.

The counters of the recording apparatus and the reproducing apparatus, operate in response to a system clock signal. For instance, according to the MPEG-2 standard, the counters basically use a 27 MHz clock signal since a system generates time stamps in response to the 27 MHz clock signal. Alternatively, system clock signals with different frequencies may be used. The ATS generator adds a respective ATS to each packet data input to the recording apparatus. The recording controller converts the packet data with the ATSs into a recordable signal and records the recordable signal on a storage medium.

The reproduction controller of the reproducing apparatus reads back the packet data with the ATSs from the storage medium and transmits the read data to the ATS processor. Next, the ATS processor outputs the packet data based on the ATSs added to the packet data. Each of the ATS generator and the ATS processor includes a buffer (not shown) that temporarily stores the packet data with the ATSs. Such a buffer may be installed outside each of the ATS generator and the ATS processor.

A method of adding ATSs to packet data will now be described in detail. First, the ATS generator reads a counter value of the counter when the packet data is input to the recording apparatus and adds the read counter value to the related packet data. That is, the counter value read when the packet data is input to the recording apparatus is added as an ATS to the packet data. The packet data with the ATS is temporarily stored in the buffer installed in the ATS generator and recorded on the storage medium using the recording controller. As mentioned above, the buffer may be installed outside the ATS generator.

The reproduction controller of the reproducing apparatus reads the packet data with the ATSs from the storage medium and transmits the read packet data to the ATS processor. The ATS processor, which includes a predetermined sized buffer therein, temporarily stops reading of the packet data when the buffer overflows and restarts reading of the packet data when the buffer is empty. Also, the ATS processor reads the packet data, which is first transmitted to the ATS processor buffer, and the ATS from the packet data, and outputs the packet data while resetting the counter with the ATS. The packet data output from the ATS processor is the original packet data that does not include the ATS. In connection with subsequent packet data, the ATS processor compares the respective ATSs of the subsequent packet data with the counter value and outputs only packet data whose ATS is equivalent to the counter value. As mentioned above, the buffer may be installed outside the ATS processor.

Inclusion of ATSs into packet data allows reproduction of the packet data based on intervals of time at which the original packet data was transmitted to a transmitting side to a receiving side. Accordingly, seamless reproduction of a plurality of packet data of a data stream without causing overflow or underflow of the buffer is possible.

A data stream, which contains packet data recorded to include ATSs as described with reference to FIGS. 1 and 2, is referred to as a Stream OBject (SOB). As described above, seamless reproduction of packet data contained in an SOB may be seamlessly reproduced, based on the ATSs included in the packet data.

However, seamlessly reproduction of a plurality of SOBs stored on a storage medium is difficult. An SOB is generated when a user starts and ends a write operation and another SOB is generated when the user starts and ends another write operation. In this case, a data stream refers to data recorded during which a write operation starts and ends. For instance, a drama or a movie may be recorded in a data stream format. Conventionally, continuous reproduction of packet data only in a data stream is required, and therefore, ATSs of a data stream are recorded independently with (or to be unrelated with) those of another data stream. However, when a user reproduces two data streams in series, a pause between reproductions of the two data streams is unavoidable since there are no particular regulations for continuous reproduction of two data streams.

FIG. 3 illustrates reproduction of two SOBs SOB1 and SOB2 using the conventional recording/reproducing apparatus of FIG. 2. Referring to FIG. 3, ATSs of packet data of a first SOB SOB1 are recorded starting from 100 to 990, and ATSs of packet data of a second SOB SOB2 are recorded starting from 0. In other words, the ATS generator of FIG. 2 sets an ATS 100 of first incoming packet data of the first SOB SOB1 as an initial counter value of the counter of FIG. 2 when recording the first SOB SOB1, but resets the initial counter value as an ATS 0 of first incoming packet data of the second SOB SOB2 when recording the second SOB SOB2. For continuous reproduction of two such SOBs whose ATSs are recorded to be independent of or unrelated with one another, the first SOB SOB1 is reproduced while comparing the corresponding ATSs with counter values. Next, after reproduction of the first SOB SOB1, the counter value is reset as 0 and reproduction of the second SOB SOB2 starts. However, there are no regulations regarding an interval of time between reproduction of the first and second SOBs SOB1 and SOB2, respectively, when using a conventional recording/reproducing apparatus such as that shown in FIG. 2. Accordingly, a pause is unavoidable when the counter is reset to the ATS 0 of the first incoming packet data of the second SOB SOB2.

In other words, as shown in FIG. 3, when reproducing the two SOBs SOB1 and SOB2 whose ATSs are determined to be unrelated to one another, the conventional recording/reproducing apparatus of FIG. 2 resets an initial counter value to an ATS of the first incoming packet data of the second SOB SOB2 an undetermined interval of time after reproduction of the first SOB SOB1, and starts reproduction of the second SOB SOB2, thus causing a pause in the reproduction. As a result, seamless reproduction of the first and second SOBs SOB1 and SOB2 is not guaranteed.

### SUMMARY OF THE INVENTION

The present invention provides a method of and an apparatus for guaranteeing seamless reproduction of a plurality of data streams.

According to an aspect of the present invention, there is provided a method of seamlessly reproducing a plurality of data streams that include packet data with arrival time stamps determined to be unrelated to each other, the method comprising generating control information for controlling output times of the plurality of data streams for seamless reproduction, and continuously reproducing the plurality of data streams based on the generated control information.

The control information may specify a reference time value and one of a reproduction gap length value and an offset value.

The reference time value may be obtained by adjusting an arrival time stamp of first packet data of a current data stream so that the current data stream is reproducible immediately after reproduction of a previous data stream without a pause.

The reproduction gap value may be a time value indicating an interval of time between reproduction of last packet data of the previous data stream and the first packet data of the current data stream, and the reproduction gap value may be obtained by calculating the difference between the reference time value and an arrival time stamp value of last packet data of the previous data stream.

The offset value may be added to the arrival time stamp value of each packet data of the current data stream so that the current data stream is reproducible immediately after reproduction of the previous data stream without a pause. The offset value may be obtained by calculating a difference between the reference time value and the arrival time stamp value of the first packet data of the current data stream.

According to another aspect of the present invention, there is provided an apparatus for seamlessly reproducing a plurality of data streams that include packet data with arrival time stamps determined to be unrelated to each other, the apparatus comprising a reproduction controller which reads the plurality of data streams from a storage medium, a counter which is driven in response to a system clock signal and reset based on the arrival time stamp of first packet data of each of the plurality of data streams read by the reproduction controller, an arrival time stamp processor which removes the arrival time stamps from the packet data of the plurality of data streams and outputs only the packet data, and a controller which generates control information for controlling output time of the respective packet data for seamless reproduction of the plurality of data streams, and controls operation of the counter or the arrival time stamp processor based on the control information.

The control information may specify a reference time value and one of a reproduction gap length value and an offset value.

The controller may transmit a control signal indicating when the counter must be reset, to the counter for seamless reproduction of the plurality of data streams, the control signal being obtained by combining an arrival time stamp of last packet data of the previous data stream and the reproduction gap value.

Also, the controller may change an arrival time stamp value of first packet data of the current data stream into the reference time value, change arrival time stamp values of the remaining packet data by adding the offset value to the arrival time stamp values, and provide the changed arrival time stamp values to the arrival time stamp processor.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail exemplary embodiments thereof with reference to the attached drawings in which:

FIG. 1 is a conceptual view illustrating a basic format of packet data with ATSs, and a relationship between the ATSs and output time of the packet data;

FIG. 2 is a block diagram of a conventional recording/reproducing apparatus that records and reproduces the packet data shown in FIG. 1;

FIG. 3 illustrates reproduction of two Stream OBjects (SOBs) using the conventional recording/reproducing apparatus of FIG. 2;

FIG. 4 is a block diagram of a reproducing apparatus capable of seamlessly reproducing a plurality of SOBs, according to an embodiment of the present invention;

FIGS. 5A through 5D illustrate a process of precisely calculating a reference time value for seamless reproduction of a plurality of SOBs encoded according to an MPEG standard, according to an embodiment of the present invention;

FIG. 6 is a timing chart illustrating a method of calculating the reference time value illustrated in FIGS. 5A through 5D, using equations;

FIG. 7 illustrates a method of calculating a reproduction gap value for resetting a counter and an offset value for adjusting data output time, using the reference time illustrated by FIG. 6, according to an embodiment of the present invention;

FIG. 8 is a flowchart illustrating a method of seamlessly reproducing a plurality of stream objects with resetting a counter, according to an embodiment of the present invention; and

FIG. 9 is a flowchart illustrating a method of seamlessly reproducing a plurality of stream objects without resetting a counter, according to another embodiment of the present invention.

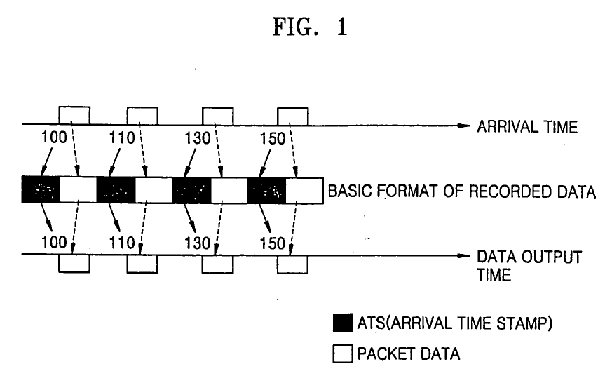

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 4 is a block diagram of a reproducing apparatus for seamlessly reproducing a plurality of SOBs, according to an embodiment of the present invention. The reproducing apparatus of FIG. 4 comprises a reproduction controller 410, a controller 420, a counter 430, and an arrival time stamp (ATS) processor 440.

The reproduction controller 410 sequentially reads a plurality of SOBs from a storage medium 400. For reproduction of a first SOB SOB1, the ATS processor 440 resets the counter 430 based on an ATS of first incoming packet data and at the same time, outputs the first incoming packet data to a decoder (not shown). Next, the ATS processor 440 compares ATSs of subsequent packet data with counter values of the counter and outputs only packet data whose ATSs are equivalent to the counter values.

After outputting all packet data of the first SOB SOB1, the controller 420 calculates a time when first packet data of a second SOB SOB2 is to be output and when the counter 430 must be reset, and provides results of the calculating to the ATS processor 440 and the counter 430, respectively. Equations used to calculate the instants of time are described below. In other words, for seamless reproduction of a plurality of SOBs, the controller 420 either adjusts ATSs of the second SOB SOB2 and informs the ATS processor 440 of the adjusted ATSs, or determines when the counter 430 must be reset and transmits a control signal indicating a result of the determination to the counter 430.

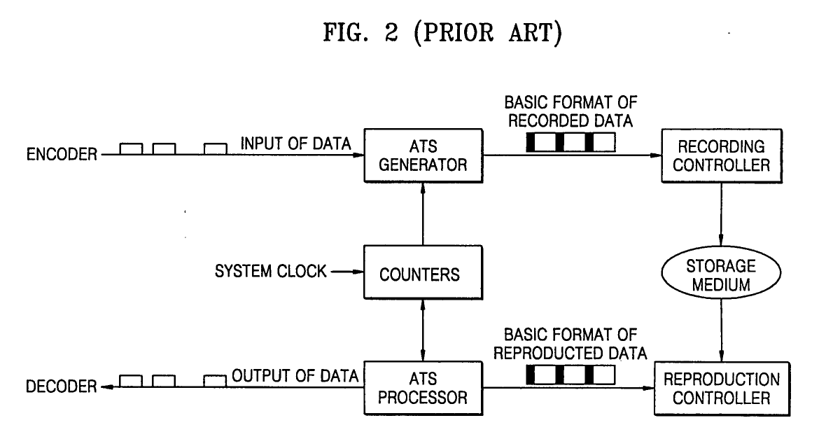

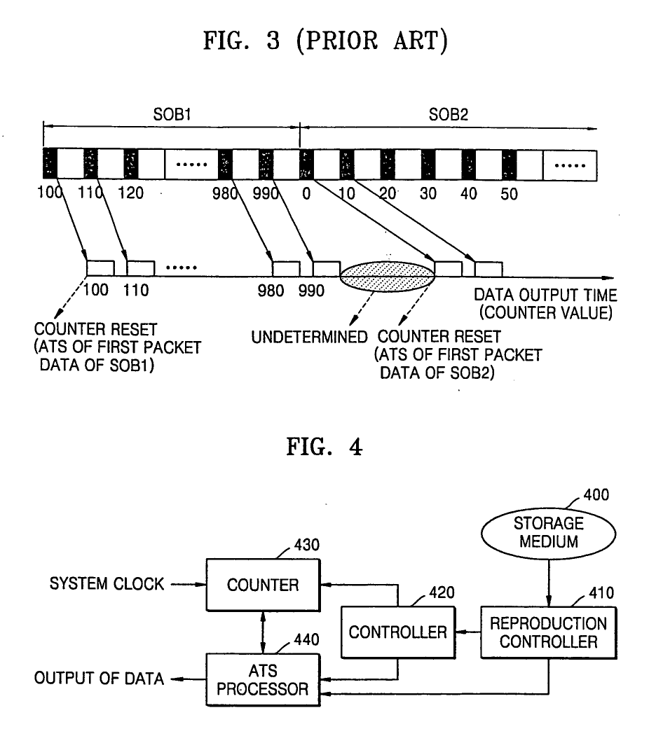

The counter 430 operates in response to a system clock and is reset according to an ATS of a first incoming packet data of an SOB read by the reproduction controller 410. In particular, for continuous reproduction of a plurality of SOBs, the counter 430 is reset in response to the control signal that is input from the controller 420 and instructs when the counter 430 must be reset. As described above, there are no regulations regarding an interval of time between reproduction of two SOBs whose ATSs are determined to be unrelated to each other, when using a conventional reproducing apparatus such as that shown in FIG. 2. Therefore, a pause in reproduction of the two SOBs is unavoidable. To solve this and/or other problems, the reproducing apparatus of FIG. 4 reproduces a current SOB after reproduction of a previous SOB, in response to the control signal input from the controller 420 that instructs when the counter 430 must be reset, thereby guaranteeing seamless reproduction.

For seamless reproduction, the ATS processor 440 receives the adjusted ATSs from the controller 420 and controls output times of packet data of a subsequent SOB based on the adjusted ATSs. Otherwise, the ATS processor 440 resets the counter 430 in response to the control signal instructing when the counter 430 must be reset from the controller 420, and controls output times of packet data of a subsequent SOB.

According to the present invention, one of the following methods (1) and (2) is used to seamlessly reproduce a plurality of SOBs.

In the method (1), the counter 430 is reset in response to a control signal input from the controller 420 that instructs when the counter 430 must be reset, and then, a current SOB is reproduced after reproduction of a previous SOB by controlling output time of packet data of the current SOB.

In the method (2), a current SOB is reproduced after reproduction of a previous SOB by controlling output time of packet data of the current SOB based on adjusted ATSs of the packet data input from the controller 420, without resetting the counter 430.

The above methods will now be described in greater detail.

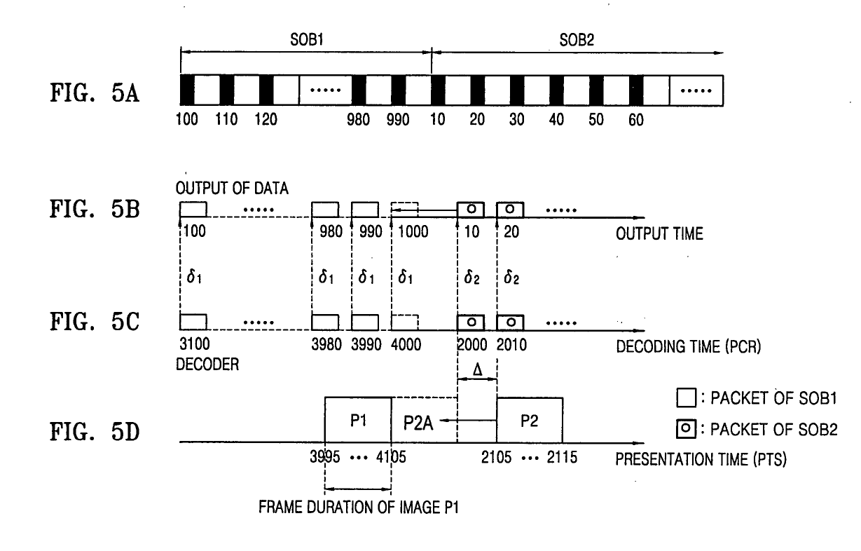

FIG. 5 is a reference diagram illustrating a method of calculating a reference time value for guaranteeing seamless reproduction of a plurality of SOBs encoded according to the MPEG standards. FIG. 5A illustrates two SOBs SOB1 and SOB2 that are to be reproduced. Packet data of the first SOB SOB1 are given ATSs numbered starting from 100 to 990, and packet data of the second SOB SOB2 are given ATSs numbered starting from 10 regardless of the ATSs of the packet data of the first SOB SOB1. Therefore, for seamless reproduction of the SOBs SOB1 and SOB2, an interval of time between reproduction of last packet data of the first SOB SOB1 with the ATS 990 and first packet data of the second SOB SOB2 with the ATS 10, must be predetermined.

ATSs of packet data shown in FIG. 5B are based on a clock value of an arrival time clock (ATC) used to generate the ATS. The ATS processor 440 of FIG. 4 removes ATSs from the packet data and outputs only the packet data to a decoder.

FIG. 5B illustrates output time of the packet data using ATC-based time values.

A receiving side must decode packet data in synchronization with a system clock that a transmitting side uses to encode the packet data. Program clock reference (PCR) values shown in FIG. 5C use system time clock (STC)-based time values. After the receiving side receives packet data, an STC of a reproducing apparatus at the receiving side is set based on PCR values contained in a SOB, thereby synchronizing system clocks of the transmitting side and the receiving side.

In the reproducing apparatus at the receiving side, when packet data is received, corresponding ATS values of an SOB correspond to PCR values at predetermined intervals δ of time. Referring to FIGS. 5B and 5C, ATS values of the first SOB SOB1 correspond to PCR values at a predetermined interval δ₁ of time, and ATS values of the second SOB SOB2 correspond to PCR values at a predetermined interval δ₂ of time.

FIG. 5D illustrates presentation time stamps (PTSs) of data encoded according to an MPEG-transport stream (MPEG-TS) standard. For instance, the PTS indicates an amount of time required to present an image on a screen. In general, an image comprises a plurality of packet data and the plurality of packet data are referred to as a packetized elementary stream (PES). A PTS is contained in a start of the PES. In general, a PTS of packet data is determined to be larger than a PCR value of the packet data.

Seamless reproduction of two SOBs will now be defined. Referring to FIG. 5D, for reproduction of MPEG video data, a first image P2 of the second SOB SOB2 must be presented immediately after a last image P1 of the first SOB SOB1 without a pause. In other words, the image P2 must be reproduced immediately after the reproduced image P1; that is, the PTS of the image P2 must be changed to the PTS of an image P2A. A PTS of the image P2A is computed by combining a PTS 3995 of the image P1 with a frame duration value of 110 of the image P1. In this case, the PTS of the image P2A is 4105.

It is assumed that the difference value between the PTS value and PCR value of the image P2 is Δ. Referring to FIGS. 5C and 5D, the difference value Δ between a PTS value of 2105 of the image P2 and a PCR value of 2000 of first packet data of the second SOB SOB2 is 105. In consideration of a decoding time, in order to make the image P2 be presented immediately after the image P1, a PCR value of the image P2A must be smaller than the PTS of the image P2A by the difference value Δ. That is, a new PCR value of the image P2A is computed by subtracting the difference value Δ of 105 from the PTS value of 4105 of the image P2A. In this case, the new PCR value of the image P2A is 4000.

Referring to FIGS. 5B and 5C, difference values between the corresponding PCR values and ATSs of the first SOB SOB1 are δ1, i.e., 3000. Accordingly, when subtracting the difference value δ1 from the PCR value of 4000 of the image P2A, an ATS of the image P2A is 1000. The ATS 1000 of the image P2A denotes a time value indicating when first packet data of the second SOB SOB2 must be reproduced after reproduction of last packet data of the first SOB SOB1. In this disclosure, the ATS of the image P2A will be referred to as a reference time value.

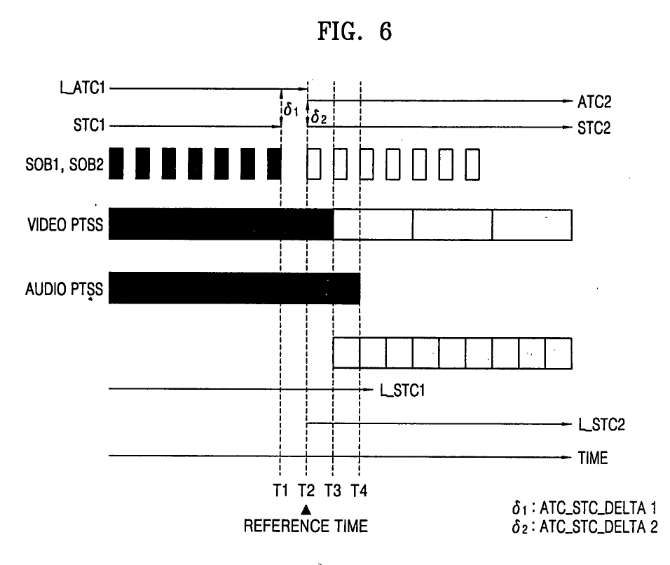

FIG. 6 is a timing chart illustrating a method of calculating the reference time value illustrated by FIG. 5, using equations. Referring to FIG. 6, L_STC1 denotes a time axis along a line connecting the STCs of the first SOB SOB1, and L_STC2 denotes a time axis along a line connecting the STCs of the second SOB SOB2. For seamless reproduction of the two SOBs SOB1 and SOB2, the time axis L_STC2 is converted into a time axis L_STC1 extended from the time axis STC1 by compensating for the difference STC_delta between the time axes L_STC1 and L_STC2. According to the new generation optical disc technology “Blu-ray Disc (part 3)”, this conversion may be expressed by the following:
L_{—}STC2=L_{—}STC1−STC_delta (1),
wherein L_STC1 denotes a long STC obtained from the STCs of the first SOB SOB1, L_STC2 denotes a long STC obtained from the STCs of the second SOB SOB2, and STC_delta denotes the difference between the STCs L_STC1 and L_STC2.

As explained with reference to FIGS. 5A-5D, the difference value δ between corresponding ATSs and PCR values of an SOB is caused by the difference between generations of an ATC clock and an STC clock. The difference value δ is referred to as ATC_STC_delta. It is assumed that the difference between an STC STCI and an ATC ATC1 of the first SOB SOB1 is ATC_STC_delta1 (δ₁) and the difference between a STC STC2 and an ATC ATC2 of the second SOB SOB2 is ATC_STC delta2 (δ₂). In this case, the long STC L_STC1 and the long STC L-STC2 may be expressed as ATC1+ATC_STC_delta1 and ATC2+ATC_STC_delta2, respectively.

Therefore, Equation (1) may be expressed as follows:
ATC2+ATC_STC_delta2=L_{—}ATC1+ATC_{—}STC_delta1−STC_delta (2),

Referring to FIG. 6, for seamless reproduction of the two SOBs SOB1 and SOB2, a reference time value is determined by an ATC L_ATC2 obtained from ATCs of the second SOB SOB2 in a long ATC L_ATC1 of the first packet data of the second SOB SOB2. The reference time value is illustrated by T2 in FIG. 6 and can be expressed as T2_L_ATC1. Based on Equation (2), the reference time value T2_L_ATC1 is calculated by the following:
T2_{—}ATC2+ATC_{—}STC_delta2=T2_{—}L_{—}ATC1+ATC_{—}STC_delta1−STC_delta T2_{—}L_{—}ATC1=T2_{—}ATC2+ATC_{—}STC_delta2+STC_delta−ATC_{—}STC_delta1 (3)

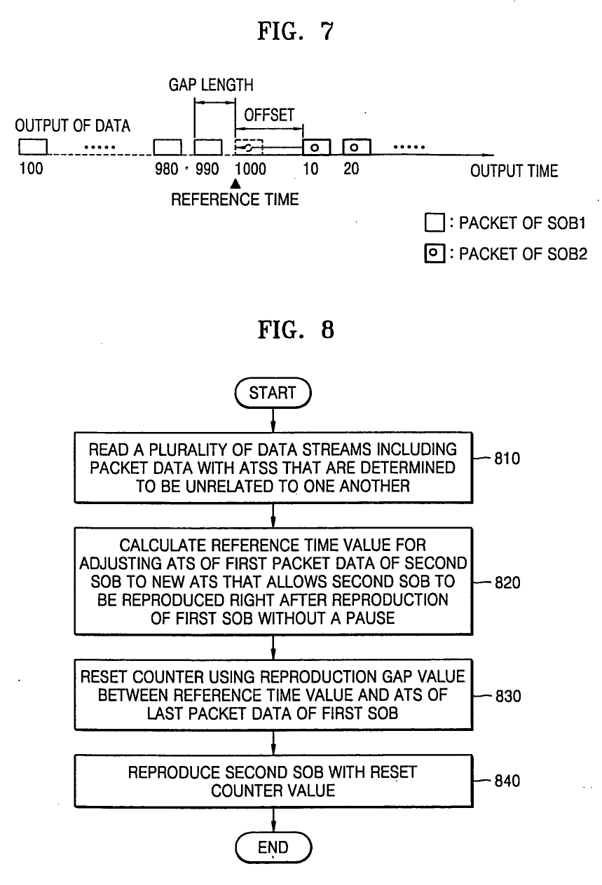

FIG. 7 illustrates a method of calculating a reproduction gap value for resetting a counter and an offset value for adjusting data output time, using the reference time T2_L_ATC1 described with reference to FIG. 6, according to an embodiment of the present invention. Referring to FIGS. 4 and 7, the reproduction gap value gap length denotes a period of pause in reproduction of two SOBs SOB1 and SOB2, i.e., the difference between the reference time T2_L_ATC1 and the ATS of the last packet data of the first SOB SOB1. The reproduction gap value gap length is used in the method (1) described with reference to FIG. 4, i.e., when the controller 420 resets the counter 430. Referring to FIG. 7, the counter 430 is reset to the ATS of first packet data of the second SOB SOB2 and reproduction of the second SOB SOB2 starts, after time corresponding to the reproduction gap value gap length has lapse starting from time corresponding to the ATS of the last packet data of the first SOB SOB1. Accordingly, a time when the counter 430 must be reset may be determined using the reproduction gap value gap length, thereby ensuring seamless reproduction of a plurality of SOBs.

In FIG. 7, an offset value offset denotes a difference value between the reference time T2_L_ATC1 and the ATS of the first packet data of the second SOB SOB2. The offset value offset is used in the method (2) described with reference to FIG. 4, i.e., when the second SOB SOB2 is reproduced after reproduction of the first SOB SOB1 without resetting the counter 430. In the method (2), new ATSs of the second SOB SOB2 are obtained by adding the offset value offset to the original ATSs and reproduction of the second SOB SOB2 begins based on the new ATSs without resetting the counter 430. Accordingly, an effect of reproducing the first and second SOBs SOB1 and SOB2 in response to the same ATC may be drawn, thereby guaranteeing seamless reproduction.

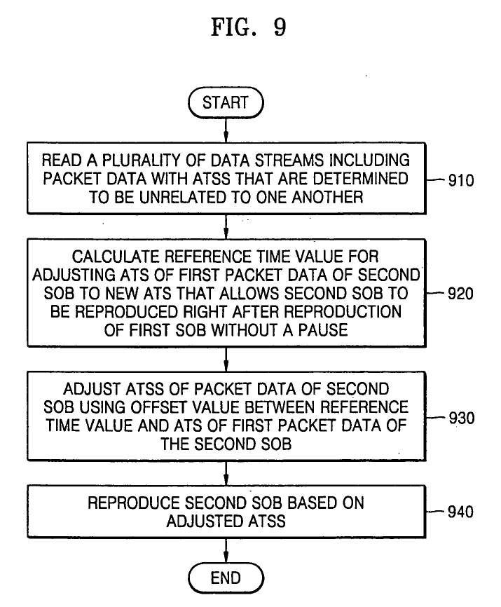

The methods (1) and (2) will now be described with reference to FIGS. 8 and 9.

FIG. 8 is a flowchart illustrating the method (1) described with reference to FIG. 4, that is, a method of controlling output time of a second SOB SOB2 so that the second SOB SOB2 is reproduced immediately after reproduction of a first SOB SOB1 with resetting a counter, according to an embodiment of the present invention. Referring to FIG. 8, for seamless reproduction, the first and second SOBs SOB1 and SOB2, which include packet data with ATSs, are read from a storage medium, the ATSs of the packet data of the first SOB SOB1 being determined to be unrelated to those of the packet data of the second SOB SOB2 (operation 810). Next, a reference time value used to adjust the ATS of first packet data of the second SOB SOB2 is calculated to a new ATS so that the second SOB SOB2 is reproducible immediately after reproduction of the first SOB SOB1 without a pause (operation 820). Next, the counter is reset using a reproduction gap value that is a difference value between the calculated reference time value and an ATS of last packet data of the first SOB SOB1 (operation 830). Thereafter, reproduction of the second SOB SOB2 starts with a reset counter value (operation 840).

FIG. 9 is a flowchart illustrating the method (2) described with reference to FIG. 4, that is, a method of controlling output time of a second SOB SOB2 without resetting a counter so that the second SOB may be reproduced immediately after reproduction of a first SOB SOB1, according to an embodiment of the present invention. Referring to FIG. 9, operations 910 and 920 are the same as operations 810 and 820 of FIG. 8, and therefore, a description thereof will be omitted. After operation 920, ATSs of packet data of the second SOB SOB2 are adjusted using an offset value between a calculated reference time value and an ATS of first packet data of the second SOB SOB2 (operation 930). Next, reproduction of the second SOB SOB2 starts based on the adjusted ATSs (operation 940).

According to the present invention, a plurality of SOBs may be seamlessly reproduced using the method (1) of FIG. 8 or the method (2) of FIG. 9. Alternatively, a combination of the method (1) of FIG. 8 and the method (2) of FIG. 9 may be used to seamlessly reproduce the plurality of SOBs.

The present invention may be embodied as computer readable code on a computer readable medium. The computer readable medium is any data storage device that can store data that can thereafter be read by a computer system. Examples of the computer readable medium include read-only memory, random-access memory, CD-ROMs, magnetic tape, floppy discs, and optical data storage devices. The computer readable medium may be a carrier wave that transmits data via the Internet. The computer readable medium may also be distributed over a network coupled computer system so that the computer readable code is stored and executed in a distributed fashion.

As described above, according to the present invention, a plurality of SOBs, ATSs of packet data of which are determined to be unrelated to each another, may be seamlessly reproduced by adjusting the ATSs of packet data of subsequent SOBs using a reference time value.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of seamlessly reproducing a plurality of data streams that include packet data with arrival time stamps determined to be unrelated to each other, the method comprising:
generating control information for controlling output times of the plurality of data streams for seamless reproduction; and
continuously reproducing the plurality of data streams based on the generated control information.

2. The method of claim 1, wherein the control information specifies a reference time value and one of a reproduction gap length value and an offset value.

3. The method of claim 2, wherein the reference time value is obtained by adjusting an arrival time stamp of first packet data of a current data stream so that the current data stream is reproducible immediately after reproduction of a previous data stream without a pause.

4. The method of claim 3, wherein the reproduction gap value is a time value indicating an interval of time between reproduction of last packet data of the previous data stream and the first packet data of the current data stream.

5. The method of claim 4, wherein the reproduction gap value is obtained by calculating a difference between the reference time value and an arrival time stamp value of last packet data of the previous data stream.

6. The method of claim 3, wherein the offset value is added to the arrival time stamp value of each packet data of the current data stream so that the current data stream can be reproduced immediately after reproduction of the previous data stream without a pause.

7. The method of claim 6, wherein the offset value is obtained by calculating a difference between the reference time value and the arrival time stamp value of the first packet data of the current data stream.

8. An apparatus for seamlessly reproducing a plurality of data streams that include packet data with arrival time stamps determined to be unrelated to each other, the apparatus comprising:
a reproduction controller which reads the plurality of data streams from a storage medium;
a counter which is driven in response to a system clock signal and reset based on the arrival time stamp of first packet data of each of the plurality of data streams read by the reproduction controller;
an arrival time stamp processor which removes the arrival time stamps from the packet data of the plurality of data streams and outputs only the packet data; and
a controller which generates control information for controlling output time of the respective packet data for seamless reproduction of the plurality of data streams, and controls operation of the counter or the arrival time stamp processor based on the control information.

9. The apparatus of claim 8, wherein the control information specifies a reference time value and one of reproduction a gap length value and an offset value.

10. The apparatus of claim 9, wherein the reference time value is obtained by adjusting an arrival time stamp of first packet data of a current data stream so that the current data stream is reproducible immediately after reproduction of a previous data stream without a pause.

11. The apparatus of claim 10, wherein:
the reproduction gap value is a time value indicating an interval of time between reproduction of last packet data of the previous data stream and the first packet data of the current data stream, and
the controller transmits a control signal indicating when the counter must be reset, to the counter for seamless reproduction of the plurality of data streams, the control signal being obtained by combining an arrival time stamp of last packet data of the previous data stream and the reproduction gap value.

12. The apparatus of claim 11, wherein the reproduction gap value is obtained by calculating a difference between the reference time value and an arrival time stamp value of the last packet data of the previous data stream.

13. The apparatus of claim 11, wherein:
the offset value is added to the arrival time stamp value of each packet data of the current data stream so that the current data stream is reproducible immediately after reproduction of the previous data stream without a pause, and
the controller changes an arrival time stamp value of first packet data of the current data stream into the reference time value, changes arrival time stamp values of the remaining packet data by adding the offset value to the arrival time stamp values, and provides the changed arrival time stamp values to the arrival time stamp processor.

14. The apparatus of claim 13, wherein the offset value is obtained by calculating a difference between the reference time value and the arrival time stamp value of the first packet data of the current data stream.

15. A computer readable medium for seamlessly reproducing a plurality of stream objects comprising packet data and an arrival time stamp, the computer readable medium comprising instructions which:
instruct a processor to adjust an arrival time stamp of first packet data of a current stream object based on a reference time and one of a gap length value and an offset value; and
instruct the processor to reproduce the current data stream immediately after a previous data stream without a pause based on the adjusted arrival time stamp.

16. The computer readable medium of claim 15, further comprising instructions which:
instruct the processor to determine the gap length value as an interval of time between reproduction of last packet data of the previous data stream and the first packet data of the current data stream.

17. The computer readable medium of claim 16, further comprising instructions which:
instruct the processor to determine the gap length value by calculating a difference between the reference time value and an arrival time stamp value of last packet data of the previous data stream.

18. The computer readable medium of claim 15, further comprising instructions which:
instruct the processor to add the offset value to the arrival time stamp value of each packet data of the current data stream.

19. The computer readable medium of claim 18, further comprising instructions which:
instruct the processor to determine the offset value by calculating a difference between the reference time value and the arrival time stamp value of the first packet data of the current data stream.
